(19) United States
(12) Patent Application Publication
(10) Pub. No.: US 2008/0055525 A1
(43) Pub. Date: Mar. 6, 2008

(54) LIQUID CRYSTAL DISPLAY DEVICE

(76) Inventors: Koichi Igeta, Chiba (JP); Hirotaka Imayama, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/850,101

(22) Filed: Sep. 5, 2007

(30) Foreign Application Priority Data
Sep. 6, 2006 (JP) 2006-241294

(51) Int. Cl. G02F 1/1335

(52) U.S. Cl. 349/114

(57) ABSTRACT

A liquid crystal display device improved with the luminance in a reflection portion, including a liquid crystal display panel having a first substrate, a second substrate and liquid crystals put between the first substrate, and the second substrate in which the liquid crystal display panel has a plurality of sub-pixels, the plurality of sub-pixels have, as one basic unit, at least three first to third transmission type sub-pixels and a reflection type sub-pixel, the first to third transmission type sub-pixels and the reflection type sub-pixel are independently driven under control, the first transmission type sub-pixel displays a first color, the second transmission type sub-pixel displays the second color, the third transmission sub-pixel displays a third color, and the reflection type sub-pixel displays a white color.

### CLAIM OF PRIORITY

The present application claims priority from Japanese Application JP 2006-241294 filed on Sep. 6, 2006, the content of which is hereby incorporated by reference into this application.

### BACKGROUND OF THE INVENTION

(1) Field of the Invention

The present invention concerns a liquid crystal device and, more particularly, it relates to a technique which is effective to the application for all semi-transmitting type liquid crystal display devices not being restricted to a TN (twisted Nematic) system, an ECB (Electrically Controlled Birefringence) system, a VA (Vertical Alignment) system, and an IPS (In-Plane Switching) system.

(2) Description of Related Art

A liquid crystal display panel is an optical device for controlling transmission and not transmission of a light by applying an electric field to liquid crystals kept between two opposed substrates and displaying brightness and darkness, which can be classified into three types of transmission type, reflection type, and semi-transmission type.

The transmission type liquid crystal display panel controls the transmittance of a light illuminated from a light source disposed on the side opposite to a view surface (back light) by a liquid crystal display panel and this is used mainly for indoor application.

The reflection type liquid crystal display panel reflects a light incident from the view surface by a reflection plate disposed in a liquid crystal display panel and controls the reflectance upon reflection and is used mainly for outdoor application.

The semi-transmission type liquid crystal display panel has both the transmission type and the reflection type and can be used both for the indoor use and the outdoor use.

FIG. 28 is a plan view showing a sub-pixel constitution of an existent semi-transmission type liquid crystal display panel.

FIG. 29 is a cross sectional view showing an example of a schematic cross sectional structure taken along line A-A′ in FIG. 28, and FIG. 30 is a cross sectional view showing another example of a schematic cross sectional structure taken along line A-A′ in FIG. 28.

The semi-transmission type liquid crystal display device shown in FIG. 28 to FIG. 30 is a semi-transmission type liquid crystal display device of the VA (vertical alignment mode, negative liquid crystals) system, in which 30 denotes a transmission portion and 31 denotes a reflection portion in FIG. 28 to FIG. 30.

In the existent semi-transmission type display panel shown in FIG. 28 to FIG. 30, a pair of glass substrates (SUB1; SUB2) are disposed with a liquid crystal layer (LC) being put therebetween. In the existent semi-transmission type display panel shown in FIG. 28 to FIG. 30, the side of the main surface of the glass substrate (SUB2; also referred to as a CF substrate) constitutes the view side.

On the side of the liquid crystal layer of the glass substrate (SUB2), a light shielding film (also referred to as black matrix) (BM), a color filter (CFR), a protective film (OC), a counter electrode (CE; also referred to as a common electrode), and an alignment film (AL2) are formed orderly from the glass substrate (SUB2) to the liquid crystal layer (LC). A retardation plate (RET2) and a polarization plate (POL2) are disposed to the outside of the glass substrate (SUB2).

Further, on the side of the liquid crystal layer of the glass substrate (SUB1; also referred to as TFT substrate), a thin film transistor (TFT), an interlayer dielectric film (PAS1), a scanning line (also referred to as a gate line) (not illustrated), an interlayer dielectric film (PAS2), a video line (also referred as a source line or drain line) (not illustrated), a pixel electrode (PE), a reflection electrode (RE), an alignment film (AL1) are formed orderly from the glass substrate (SUB1) to the liquid crystal layer (LC). A retardation plate (RET1) and a polarization plate (POL1) are disposed to the outside of the glass substrate (SUB1). In FIG. 30, the alignment films (AL1, AL2), the polarization plates (POL1, POL2) and the retardation plates (RET1, RET2) are not illustrated.

In the existent semi-transmission type liquid crystal display panel shown in FIG. 28 to FIG. 30, the transmission portion 30 and the reflection portion 31 display the brightness and the darkness of a light by utilizing the birefringence of the retardation plates (RET1, RET2) and the liquid crystal layer (LC).

The cell gap length of the reflection portion 31 is set to about one-half of the cell gap length of the transmission portion 30. This is determined for substantial alignment of the optical channel length between the transmission portion 30 and the reflection portion 31 since the light passes reciprocally twice in the reflection portion 31.

Related arts relevant to the present invention includes the followings:

### Japanese Patent Application Laid-Open Publication No. 2004-93670

Japanese Patent Application Laid-Open Publication No. H11-295717

In the existent semi-transmission type liquid crystal display panel, 1-sub pixel comprises the transmission portion 30 and the reflection portion 31 and, for color display, each sub pixel has to be provided with a color filter for red (R), green (G), blue (B), respectively.

Then, for making the gradation-luminance characteristic similar between the transmission portion 30 and the reflection portion 31 and using the maximum value both for the transmittance and the reflectance, it is necessary to set the cell gap ratio between the transmission portion 30 and the reflection portion 31 to about 2:1 and substantially align the optical channel length (optical phase difference) of the transmission portion 30 and reflection portion 31. However, provision of a step between the transmission portion 30 and the reflection portion 31 disturbs the alignment of liquid crystal molecules at the stepped portion to result in a problem of causing light leakage upon black display as shown at PA1 in FIG. 29.

In view of the above, it is necessary to shield the light leakage at the stepped portion by a metal or light shielding film (BM). However, since the light shielding region for the stepped portion (region shown by TB2 in FIG. 30) overlaps with a portion of the transmission portion 30 and a portion of a reflection portion 31, the aperture ratio is lowered by so much to result in a problem of sacrificing the transmittance and the reflectance.

Further, taking notice only on the reflection portion 31, the reflection portion 31 is divided into plural regions such as RR, RG, RB and, since the boundary between each of them is separated by a signal line or light shielding film (MB), this results in a problem of lowering the reflection aperture ratio by so much. TB1 in FIG. 29 and FIG. 30 shows a light shielding region shielded by a light shielding film (BM) formed to a region other than the stepped portion.

Further, since the light in the reflection portion 31 passes through the color filter twice by reciprocation, that is, incidence and reflection of an external light, this increases absorption of light to result in a problem of lowering the reflection luminance.

For addressing such a problem, Japanese Patent Application Laid-Open Publication No. 2004-93670 discloses a constitution of disposing a color filter only for the transmission portion 30 and not disposing the color filter for the reflection portion 31. Also in this case, while the reflectance is improved the reflectance is not yet sufficient.

Further, while Japanese Patent Application Laid-Open Publication No. H11-295717 discloses to constitute a 1 pixel by R, G, B, W sub-pixels, it does not disclose to constitute the W sub-pixel by a reflection type.

The present invention has been achieved for solving the problems in the related art and the invention intends to provide a technique capable of improving the luminance in the reflection portion in a liquid crystal display device.

The foregoing and other objects, as well as novel features of the invention will become apparent in accordance with the descriptions of the present specification and appended drawings.

### SUMMARY OF THE INVENTION

Among the inventions disclosed in the present application, the outline for typical inventions are to be described simply as below.

(1) A liquid crystal display device including: a first substrate; a second substrate; and a liquid crystal display panel having liquid crystals put between the first substrate and the second substrate, wherein: the liquid crystal display panel has a plurality of sub-pixels; the plurality of sub-pixels have, as one basic unit, at least three first to third transmission type sub-pixels and a reflection type sub-pixel; the first to third transmission type sub-pixels and the reflection type sub-pixel are independently driven under control; the first transmission type sub-pixels displays a first color (for example, red); the second transmission type sub-pixels displays a second color (for example, green); the third transmission type sub-pixels displays a third color (for example, blue); and the reflection type sub-pixel displays a white color.
(2) In (1) described above, the luminance of a white color displayed by the reflection type sub-pixel is determined based on the luminance for the first color displayed by the first transmission type sub-pixel, the luminance for the second color displayed by the second transmission type sub-pixel, and the luminance for the third color displayed by the third transmission type sub-pixel.
(3) In (2) described above, the luminance of the white color displayed by the reflection type sub-pixel is the sum for the luminance for the first color displayed by the first transmission type sub-pixel, the luminance for the second color displayed by the second transmission type sub-pixel, and the luminance for the third color displayed by the third transmission type sub-pixel.
(4) A liquid crystal display device including: a first substrate; a second substrate; and a liquid crystal display panel having liquid crystals put between the first substrate and the second substrate, wherein: the liquid crystal display panel has a plurality of sub-pixels; the plurality of sub-pixels have, as one basic unit, at least three first to third transmission type sub-pixels and a reflection type sub-pixel; the plurality of the sub-pixels are disposed such that the first to fourth reflection type sub-pixels in the four basic units are disposed periodically; the first to third transmission type sub-pixels and the reflection type sub-pixels are independently driven respectively under control; the four first transmission type sub-pixels and the first reflection type sub-pixel in the four basic units display a first color (for example, red); the four second transmission type sub-pixels and the second reflection type sub-pixel in the four basic units display a second color (for example, green); the four third transmission type sub-pixels and the third reflection type sub-pixel in the four basic units display a third color (for example, blue); and the fourth reflection type sub-pixel displays a white color.
(5) In (4) described above, the luminance for the first color displayed by the first reflection type sub-pixel is determined based on the luminance for the first color displayed to the four first transmission type sub-pixels in the four basic units, the luminance for the second color displayed by the second reflection type sub-pixel is determined based on the luminance for the second color displayed at the four second transmission type sub-pixels in the four basic units, the luminance for the third color displayed by the third reflection type sub-pixel is determined based on the luminance for the third color displayed at the four second transmission type sub-pixels in the four basic units, and the luminance for the white color displayed by the fourth reflection type sub-pixel is determined based on the luminance for the first color displayed at the four first transmission type sub-pixels among the four base units, the luminance for the second color displayed at the second transmission type sub-pixel and the luminance for the third color displayed at the four third transmission type sub-pixel.
(6) In (5) described above, the luminance for the first color displayed by the first reflection type sub-pixel is an average value of the luminance for the first color displayed at the four first transmission type sub-pixels, the luminance for the second color displayed by the second reflection type sub-pixel is an average value of the luminance for the second color displayed at the four second transmission type sub-pixels, the luminance for the third color displayed by the third reflection type sub-pixel is an average value of the luminance for the third color displayed at the four third transmission type sub-pixels, and the luminance for the white color displayed by the fourth reflection type sub-pixel is a sum of the average value of the luminance for the first color displayed to the four first transmission type sub-pixels, the average value of the luminance for the second color displayed of the four second transmission type sub-pixels and an average value of the luminance for the third color displayed at the four third transmission type sub-pixels.

### (7) In any one of (1) to (6) described above, wherein the thickness of the liquid crystals of the first to third transmission type sub-pixels is identical with the thickness of the liquid crystal layer of the reflection type sub-pixel.

(8) In (7) described above, wherein the potential difference between the minimum driving voltage and the maximum driving voltage applied to the liquid crystal layer of the reflection type sub-pixel is less than the potential difference between the minimum driving voltage and the maximum driving voltage applied to the liquid crystal layer of the first to third transmission type sub-pixels.

### (9) In any one of (1) to (6) described above, wherein the thickness for the liquid crystal layer of the reflection type sub-pixel is less than the thickness of the liquid crystals of the first to third transmission type sub-pixels.

### (10) In (9) described above, wherein the reflection type sub-pixel has a step forming layer for adjusting the thickness of the liquid crystal layer of the reflection type sub-pixel in the first substrate or the second substrate.

(11) In any one of (1) to (10), each of the plurality of sub-pixels has a pixel electrode formed on the first substrate and a counter electrode formed on the second substrate and the pixel electrode and the counter electrode generate an electric field to drive the liquid crystal.

### (12) In (11) described above, wherein the reflection type sub-pixel has a reflection electrode formed on the pixel electrode or below the pixel electrode.

(13) In any one of (1) to (10) described above, each of the plurality of sub-pixels has a pixel electrode formed above the first substrate and a counter electrode formed above the second substrate, and the pixel electrode and the counter electrode generate an electric field to drive the liquid crystals.

### (14) The reflection type sub-pixel has a reflection electrode formed above the counter electrode or below the counter electrode.

### (15) In (13) or (14) described above, the counter electrode is a planar electrode, an interlayer dielectric film is provided on the planar counter electrode, and the pixel electrode is formed on the interlayer dielectric film.

### (16) In any one of (1) to (10) described above, the reflection type sub-pixel has a retardation plate on the second substrate.

In the semi-transmission type liquid crystal display panel, one of the causes that the reflectance cannot be obtained sufficiently is that the area ratio of the non-reflection region other than the reflection region such as signal lines (video lines, scanning lines) or the light shielding film (BM) present between adjacent reflection portions of the sub-pixels is extremely large.

Accordingly, in the liquid crystal display panel of the invention, at least three types of transmission type sub-pixels used exclusively for transmission capable of displaying at least three kinds of colors and a reflection type sub-pixel used exclusively for reflection capable of displaying at least one kind of color are disposed to the semi-transmission liquid crystal display panel having both the transmission portion and the reflection portion, and the three transmission type sub-pixels and one reflection type sub-pixel are respectively driven independently under control.

According to the sub-pixel constitution of the invention, since the reflection portion can display by 1-sub-pixel, an extremely high reflection characteristic can be obtained with no substantial loss of light due to the light shielding portion such as the light shield film. Further, according to the constitution of the invention, since the reflection type sub-pixel can be controlled independently of the three transmission type sub-pixels, it is possible to substantially coincide the optical channel length (optical phase difference) without providing a step between the transmission type sub-pixel and the reflection type sub-pixel.

Accordingly, the light shielding film (BM) of shielding the light for the stepped portion is no more necessary making it possible to enhance the aperture ratio. While a monochromatic display is conducted only with the reflection type sub-pixel, since there is also display by the transmission type sub-pixel actually, color display is possible also in the display mainly comprising reflection in the outdoor reflection.

The effects obtained by typical examples among those disclosed in the present invention are to be described simply as below.

According to the liquid crystal display device of the invention, the luminance of the reflection portion can be improved.

### BRIEF DESCRIPTION OF THE DRAWINGS

These and other features, objects and advantages of the present invention will become more apparent from the following description when taken in conjunction with the accompanying drawings wherein:

FIG. 1 is a plan view showing the constitution of a sub-pixel of a liquid crystal display panel in an embodiment of the invention;

FIG. 2 is a plan view showing other example of the constitution of a sub-pixel of a liquid crystal display panel in an embodiment of the invention;

FIG. 3 is a plan view showing other example of the constitution of a sub-pixel of a liquid crystal display panel in an embodiment of the invention;

FIG. 4 is a view for explaining a method of generating a gradation voltage to be inputted to a reflection type sub-pixel (RW) in a case of displaying a white color at the reflection type sub-pixel (RW) in the embodiment of the invention;

FIG. 5 is a graph showing a relation between the gradation data for R, G, B and the luminance;

FIG. 6 is a graph showing a relation between the gradation data for W and the luminance;

FIG. 7 is a plan view showing other example of the constitution of a sub-pixel of a liquid crystal display panel in an embodiment of the invention;

FIG. 8 is a plan view showing other example of the constitution of a sub-pixel of a liquid crystal display panel in an embodiment of the invention;

FIG. 9 is a plan view showing other example of the constitution of a sub-pixel of a liquid crystal display panel in an embodiment of the invention;

FIG. 10 is a graph for explaining a method of generating a gradation voltage to be inputted to four reflection type sub-pixels RR, RG, RB, and RW in the embodiment of the invention;

FIG. 11 is a graph showing a relation between the gradation data for R and the luminance;

FIG. 12 is a graph showing a relation between the gradation data for R and the luminance;

FIG. 13 is a graph showing a relation between the gradation data for R, G, B and the luminance;

FIG. 14 is a graph showing a relation between the gradation data for W and the luminance;

FIGS. 15A and 15B are views explaining a reflection aperture ratio in the embodiment of the invention;

FIGS. 16A and 16B are views explaining a reflection aperture ratio in the embodiment of the invention;

FIG. 17 is a block diagram showing the schematic constitution of a liquid crystal display device in the embodiment of the invention;

FIG. 18 is a cross sectional view showing an example of a schematic cross section in a case of not providing difference to the thickness of a liquid crystal layer in a liquid crystal display panel of the embodiment of the invention;

FIG. 19 is a cross sectional view showing an example of a schematic cross section in a case of providing difference to the thickness of a liquid crystal layer in a liquid crystal display panel of the embodiment of the invention;

FIG. 20 is a cross sectional view showing other example of a schematic cross section in a case of providing difference to the thickness of a liquid crystal layer in a liquid crystal display panel of the embodiment of the invention;

FIG. 21 is a view for explaining the operation of a liquid crystal display panel in the embodiment of the invention;

FIG. 22 is a view for explaining the operation of a liquid crystal display panel in the embodiment of the invention;

FIG. 23 is a graph showing a relation of an application voltage (V) to transmittance (PET) and reflectance (PER) in a semi-transmission type liquid crystal display panel of VA system (vertical alignment system);

FIG. 24 is a cross sectional view showing a schematic cross sectional structure of other example of a liquid crystal display panel in the embodiment of the invention;

FIGS. 25A and 25B are views for explaining the electrode shape in the liquid crystal display panel shown in FIG. 24;

FIG. 26 is a cross sectional view showing a modified example of the liquid crystal display panel shown in FIG. 24;

FIG. 27 is a cross sectional view showing other modified example of the liquid crystal display panel shown in FIG. 24;

FIG. 28 is a plan view showing the constitution of a sub-pixel of an existent semi-transmission type liquid crystal display panel;

FIG. 29 is a cross sectional view showing an example of a schematic cross sectional structure taken along line A-A′ in FIG. 28; and

FIG. 30 is a cross sectional view showing other example of a schematic cross sectional structure taken along line A-A′ in FIG. 28.

### DETAILED DESCRIPTION OF THE PREFERRED EMBODIMENTS

The present invention is to be described specifically by way of preferred embodiments with reference to the drawings.

Throughout the drawings for explaining the preferred embodiments, those having identical functions carry identical reference numerals, for which duplicate description is to be omitted.

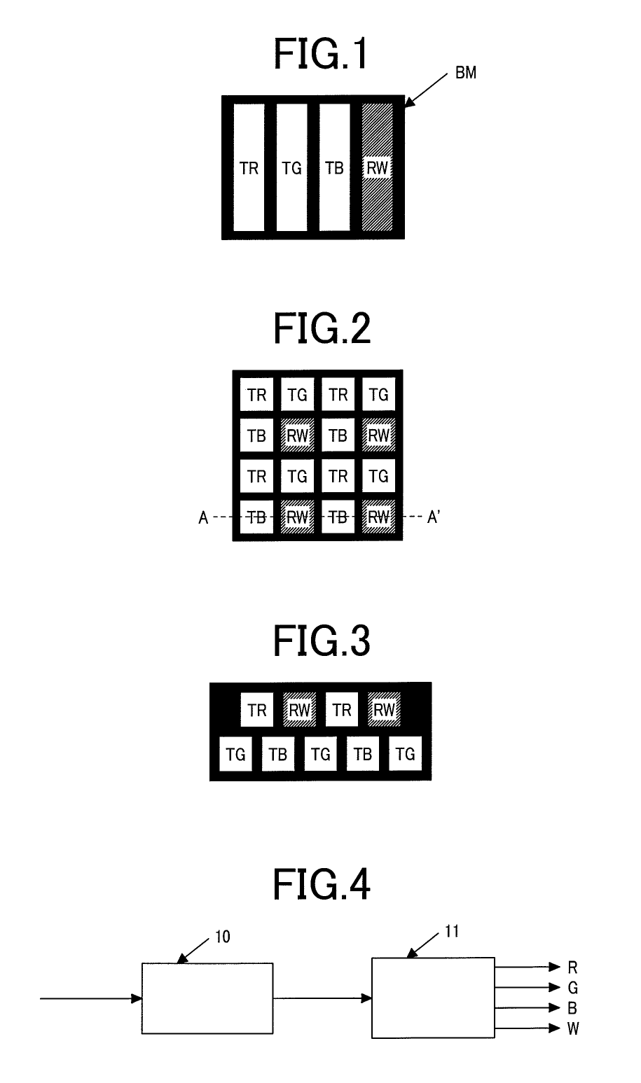

FIG. 1 is a plan view showing a sub-pixel constitution of a liquid crystal display device according to a preferred embodiment of the invention.

As shown in FIG. 1, this embodiment has, as one basic unit, at least three transmission type sub-pixels used exclusively for transmission comprising a transmission type sub-pixel (TR) used exclusively for transmission displaying a color of red (R), a transmission type sub-pixel (TG) used exclusively for transmission displaying a color of green (G), and a transmission type sub-pixel (TB) used exclusively for transmission displaying a color of blue (B) as first to third colors, and a reflection type sub-pixel (RW) used exclusively for reflection displaying a kind of color.

By replacing the reflection portion in the existent semi-transmission type liquid crystal display panel with the reflection type sub-pixel used exclusively for reflection (RW), unnecessary non-reflection regions such as signal lines or light shielding film (BM) can be eliminated and the aperture ratio of the reflection portion (that is, reflection type sub-pixel (RW)) can be improved greatly.

While monochromatic display is provided only by the reflection type sub-pixel (RW), since transmission type sub-pixels TR, TG, TB also provide display, color display is possible also in the display mainly by the reflection type sub-pixel (RW) in the outdoor or the like.

FIG. 2 and FIG. 3 are plan views showing other examples of the sub-pixel constitution in the liquid crystal display device of the embodiments of the invention.

In FIG. 2, three transmission type sub-pixels (TR, TG, TB) and a reflection type sub-pixel (RW) are arranged by 2×2, and the 2×2 basic units are arranged in a matrix.

In FIG. 3, three transmission type sub-pixels (TR, TG, TB) and a reflection type sub-pixel (RW) are arranged by 2×2 and, further, the transmission type sub-pixel TR and the reflection type sub-pixel (RW) are arranged with the position being displaced to the transmission type sub-pixels TG, TB.

In one example of the embodiment, the reflection type sub-pixel (RW) displays a white (W) color. In this case, the gradation voltage for the reflection type sub-pixel (RW) is determined depending on the gradation voltage for the three transmission type sub-pixels (TR, TG, TB).

A method of forming the gradation voltage for the reflection type sub-pixel (RW) is to be described.

FIG. 4 is a view for explaining the method of generating a gradation voltage to be inputted to the reflection type sub-pixel (RW) in a case of displaying a white color at the reflection type sub-pixel (RW).

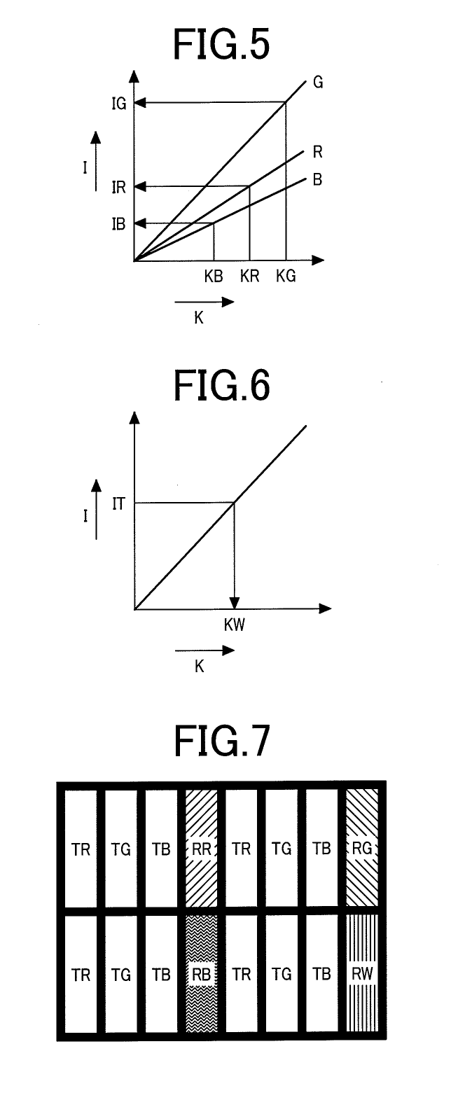

In a gradation data generation circuit 10 in FIG. 4, luminance for R, G, B (IR, IG, IB) corresponding to gradation data for R, G, B (KR, KG, KB) is determined based on the gradation (K)—luminance (I) characteristic in FIG. 5 by using, for example, a gradation-luminance table. Then, the luminance for the white color (IT) displayed at the reflection type sub-pixel (RW) is determined as the sum for the luminance of R, G, B as shown by the following equation (1).

IT=IR+IG+IB (1)

Then, gradation data for the white color (KW) corresponding to the luminance of the white color (IT) based on the gradation (K)—luminance (I) characteristic in FIG. 6 by using, for example, a gradation-luminance table.

Then, in the gradation voltage generation circuit 11, gradation voltages for R, G, B, W for outputting to the three transmission type sub-pixels (TR, TG, TB) and the reflection type sub-pixel (RW) are generated based on the gradation data for KR, KG, KB, KW, and each of the colors for R, G, B, W is displayed at a desired luminance in each of the sub-pixels.

FIG. 7 is a plan view showing other example of the sub-pixel constitution in a liquid crystal display device in the embodiment of the invention.

The example shown in FIG. 7 has, as a basic unit, at least three transmission type sub-pixels used exclusively for transmission for displaying colors R, G, B (TR, TG, TB) and a reflection type sub-pixel used exclusively for reflection for displaying a kind of color and further has, as 1 basic unit, four reflection type sub-pixels comprising a reflection type sub-pixel (RR) for displaying red (R), a reflection type sub-pixel (RG) for displaying green (G), a reflection type sub-pixel (RB) for displaying blue (B), and a reflection type sub-pixel (RW) for displaying white (W), and they are arranged periodically.

Compared with example shown in FIG. 1, by forming the colors of the color filter of respective reflection type sub-pixels, for example, of a plurality of colors such as red (R), green (G), blue (B), and white (W), the reflection type sub-pixel can also conduct color display.

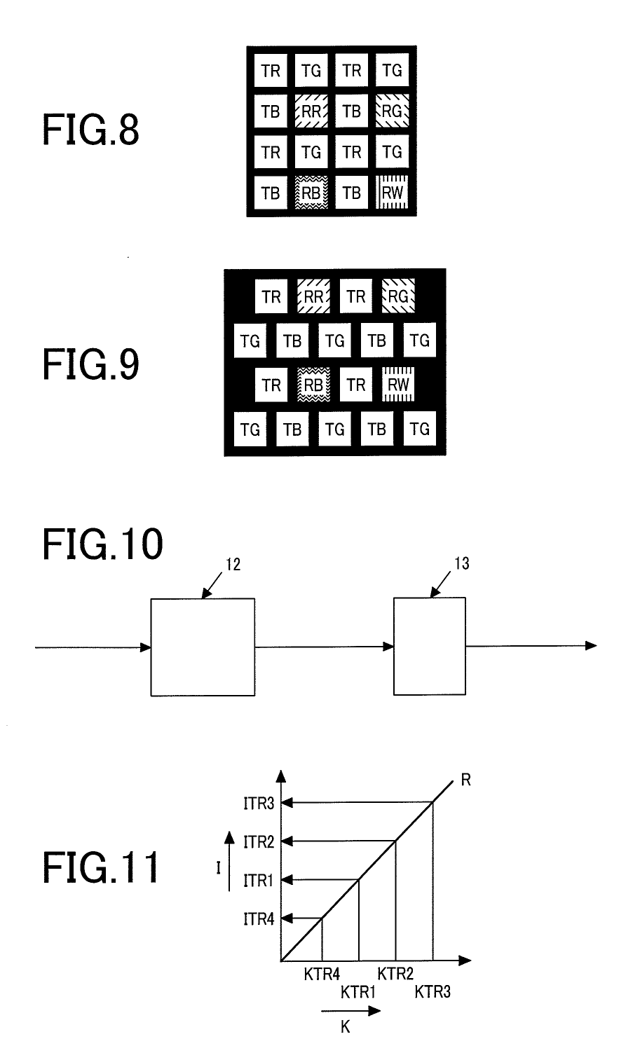

FIG. 8 and FIG. 9 are plan views showing other examples for the sub-pixel constitution of a liquid crystal display device in the embodiment of the invention.

In FIG. 8, reflection type sub-pixels are arranged periodically in the sub-pixel constitution shown in FIG. 2 such that four reflection type sub-pixels RR, RG, RB, and RW constitute a 1 basic unit.

In FIG. 9, reflection type sub-pixels are arranged periodically in the sub-pixel constitution shown in FIG. 3 such that four reflection type sub-pixels RR, RG, RB, and RW constitute a 1 basic unit.

A method of generating gradation voltages for four reflection type sub-pixels RR, RG, RB, and RW is to be described with reference to the sub-pixel constitution shown in FIG. 8 as an example.

FIG. 10 is a view for explaining the method of generating gradation voltages to be inputted to the four reflection type sub-pixels RR, RG, RB, and RW in this embodiment.

The gradation data for the reflection type sub-pixel RR (KRR) is determined based on the gradation data for adjacent four transmission type sub-pixels (TR1 to TR4).

In the gradation data generation circuit 12 in FIG. 10, respective luminance (ITR1 to ITR4) corresponding to the gradation data (KTR1 to KTR4) of the adjacent four transmission type sub-pixels (TR1 to TR4) is determined, for example, by using the gradation-luminance table based on the gradation (K)—luminance (I) characteristic in FIG. 11.

Then, as the luminance of the red color (ITRT) to be displayed at the reflection type sub-pixel (RW), an average value for the luminance of ITR1, ITR2, ITR3, and IRT4 is determined as shown by the following equation (2).

ITRT=(ITR1+ITR2+ITR3+ITR4)/4 (2)

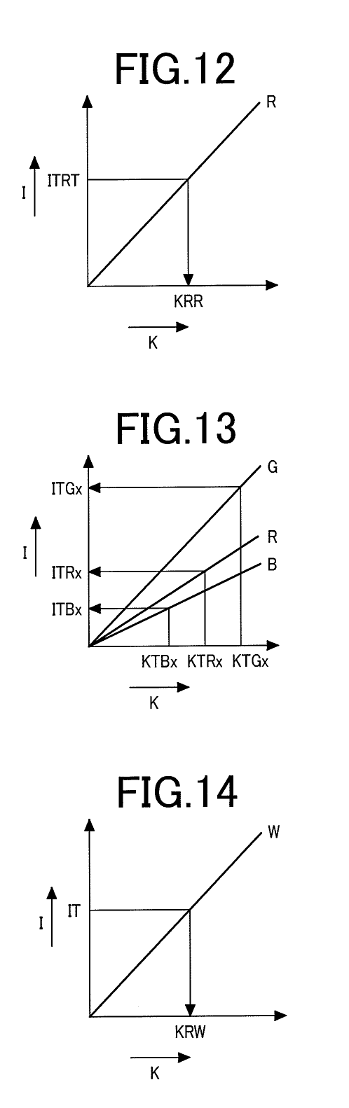

Then, the gradation data for the reflection type sub-pixel RR (KRR) corresponding to the average value for luminance (ITRT) is determined, for example, by using the gradation-luminance table based on the gradation (K)—luminance (I) characteristic shown in FIG. 12.

The gradation data for the reflection type sub-pixel RG (KRG) and the gradation date for the reflection type sub-pixel RB (KRB) are determined also in the same manner.

The gradation data (KRW) for the reflection type sub-pixel RW is determined based on the gradation data for adjacent twelve transmission type sub-pixels (TR1 to TR4, TG1 to TG4, TB1 to TB4).

In the gradation data generation circuit 12 in FIG. 10, respective luminance (ITR1 to ITR4) corresponding to the gradation data (KTR1 to KTR4) for the adjacent four transmission type sub-pixels (TRx) (x=1 to 4), respective luminance (ITG1 to ITG4) corresponding to the gradation data (KTG1 to KTG4) for adjacent four transmission type sub-pixels (TGx) (x=1 to 4), and respective luminance (ITB1 to ITB4) corresponding to the gradation data (KTB1 to KTB4) for four adjacent transmission type sub-pixels (TBx) (x=1 to 4) are determined, for example, by using a gradation-luminance table based on gradation (K)—luminance (I) characteristic in FIG. 13, and the average luminance thereof is determined.

$$IT = ( ITR 1 + ITR 2 + ITR 3 + ITR 4 ) / 4 + ( ITG 1 + ITG 2 + ITG 3 + ITG 4 ) / 4 + ( ITB 1 + ITB 2 + ITB 3 + ITB 4 ) / 4 \qquad ( 3 )$$

Then, the gradation data for the RW reflection type sub-pixel (KRW) corresponding to the average value of the luminance (IT) is determined, for example, by using a gradation-luminance table based on the gradation (K)—luminance (I) characteristic in FIG. 14.

Then, in the gradation voltage generation circuit 13, gradation voltages for the twelve transmission type sub-pixel (TR1 to TR4, TG1 to TG4, TB1 to TB4), and the gradation voltage for R, G, B, W to be outputted to the reflection type sub-pixels (RR, RG, RB, RW) are generated based on the gradation data of (KTR1 to KTR4), (KTG1 to KTG4), (KTB1 to KTB4), (KRR, KRG, KRB, KRW), and each of colors R, G, B, W is displayed at a desired luminance on each of the sub-pixels.

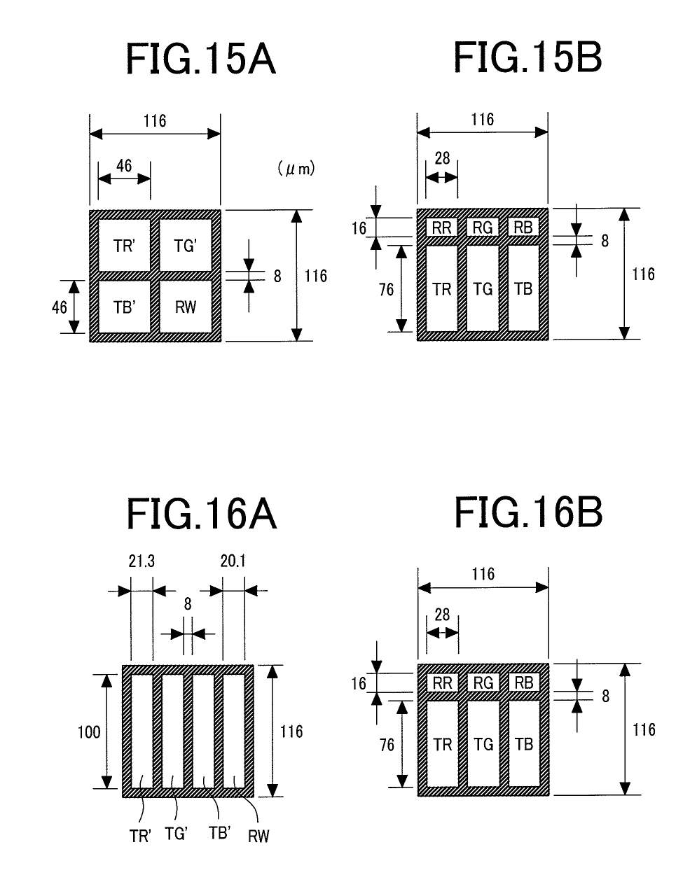

Then, the reflection aperture ratio in this embodiment is to be described with reference to FIGS. 15A, 15B, 16A and 16B.

Assuming the size for the sub-pixel as values shown in FIGS. 15A and 15B (unit: μm), in the existent sub-pixel constitution shown in FIG. 15B, the area for the transmission portion in the 1 sub-pixel is 2128 μm² (=28 μm×76 μm) and the area of the reflection portion in the 1 sub-pixel is 448 μm² (=28 μm×16 μm), and the total area for the reflection portion is 1344 μm² (=448×3).

Further, in the sub-pixel constitution of this embodiment shown in FIG. 15A, the area for the transmission type sub-pixel is 2116 μm² (=46 μm×46 μm), and the area of the reflection type sub-pixel is 2116 μm² (=46 μm×46 μm).

Assuming that the pitch for one pixel is constant and that the aperture ratio of the transmission portion is constant, that is, TR′˜TR, TG′˜TG, TB′˜TB, the reflection aperture ratio is 1.57 according to the following equation (4).

RW/(RR+RG+RB)=2116/1344˜1.57 (4)

Accordingly, the reflection aperture ratio in the case of the sub-pixel constitution shown in FIG. 15A is about 1.57 times as large as the total reflection aperture ratio of the existent sub-pixel constitution, and the reflectance can be improved remarkably compared with the existent case.

Further, assuming the size of the sub-pixel as values shown in FIGS. 16A and 16B (unit: micron) in the existent sub-pixel constitution shown in FIG. 16B, the area of the transmission portion in the 1 sub-pixel is 2128 μm² (=28 μm×76 μm), the area of the reflection portion in 1 sub-pixel is 448 μm² (=28 μm×16 μm) and the total area of the reflection portion is 1344 m² (=448×3).

Further, in the sub-pixel constitution of this embodiment shown in FIG. 16A, the area for the transmission type sub-pixel is 2130 m² (=100 μm×21.3 μm), and the area of the reflection type sub-pixel is 2010 μm² (=100 μm×20.1 μm).

Assuming that the pitch for one pixel is constant and that the aperture ratio of the transmission portion is constant, that is, TR′˜TR, TG′˜TG, TB′˜TB, the reflection aperture ratio is 1.5 according to the following equation (5).

RW/(RR+RG+RB)=2010/1344˜1.5 (5)

Accordingly, the reflection aperture ratio in the case of the sub-pixel constitution shown in FIG. 16A is about 1.50 times as large as the total reflection aperture ratio of the existent sub-pixel constitution, and the reflectance can be improved remarkably compared with the existent case.

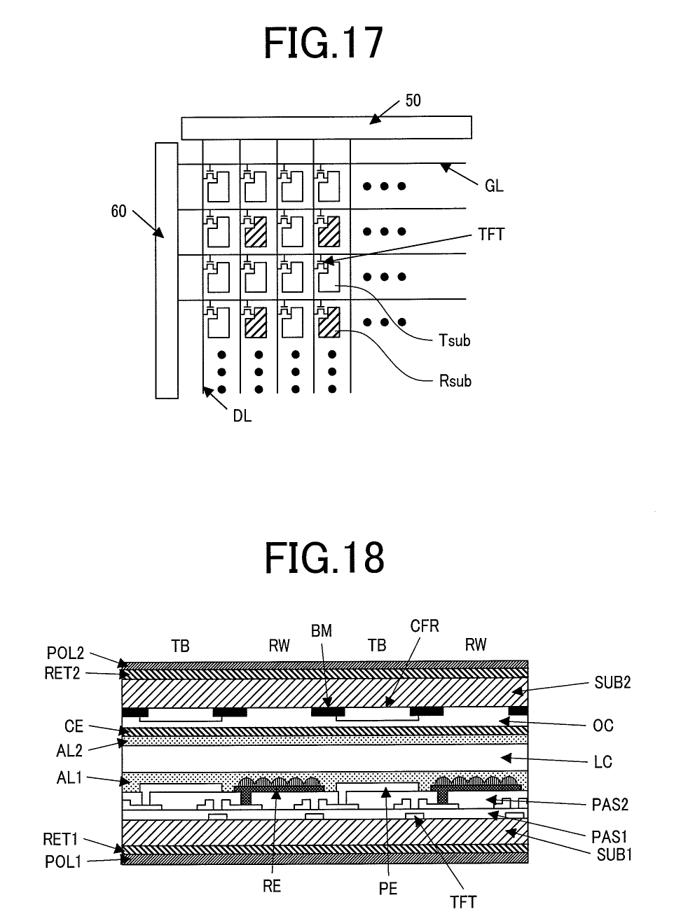

FIG. 17 is a block diagram showing the schematic constitution of a liquid crystal display device in this embodiment.

In FIG. 17, T_{sub} represents a transmission type sub-pixel, R_{sub} represents a reflection type sub-pixel, 50 represents a video line driving circuit, and 60 represents a scanning line driving circuit. The video line driving circuit 50 outputs a gradation voltage to the video line (DL). Further, the scanning line driving circuit 60 outputs a selection scanning voltage for successively turning on thin film transistors (TFT) to the scanning lines (GL).

According to this embodiment as shown in FIG. 17, since the gradation voltage can be controlled independently between the transmission type sub-pixel (T_{sub}) and the reflection type sub-pixel (R_{sub}), the optical phase difference can be coincided without providing a difference for the thickness of the liquid crystal layer (cell gap length) between the transmission type sub-pixel (T_{sub}) and the reflection type sub-pixel (R_{sub}).

FIG. 18 shows the cross sectional structure in this case. FIG. 18 is a cross sectional view showing a schematic cross sectional structure taken along line A-A′ in FIG. 2.

In FIG. 18, there are shown glass substrates SUB1, SUB2, a liquid crystal layer LC, a light shielding film BM, a color filter FR, a protective film OC, a counter electrode CE, interlayer dielectric films PAS1, PAS2, pixel electrode PE, reflection electrode RE, alignment films AL1, AL2, polarization plates POL1, POL2, retardation plates RET1, RET2, and thin film transistors TFT.

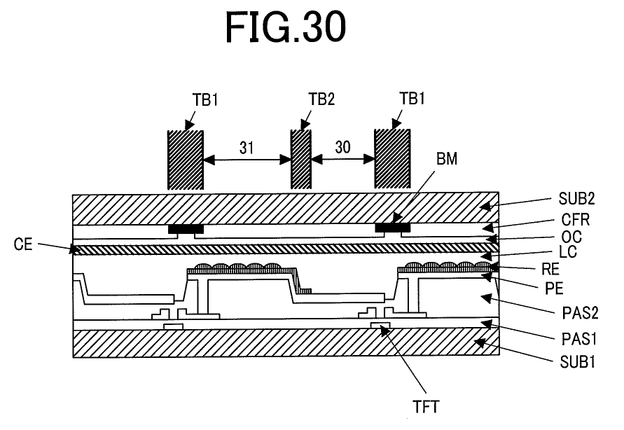

The cross sectional structure shown in FIG. 18 is different from the cross sectional structure of the existent semi-transmission type liquid crystal display panel shown in FIG. 29, FIG. 30 in that the transmission type sub-pixels (TR, TG, TB) and the reflection type sub-pixels (RW) are independent, and no step is present in the reflection type sub-pixel (RW) between the transmission type sub-pixels (TR, TG, TB) and the reflection type sub-pixel (RW) for providing a difference in the thickness of the liquid crystal layer.

The pixel electrode (PE) and the counter electrode (CT) are constituted with a transparent conductive film, for example, formed of ITO (Indium Tin Oxide).

Further, in this embodiment, a difference may be provided to the thickness of the liquid crystal layer between the transmission type sub-pixels (TR, TG, TB) and the reflection type sub-pixels (RW).

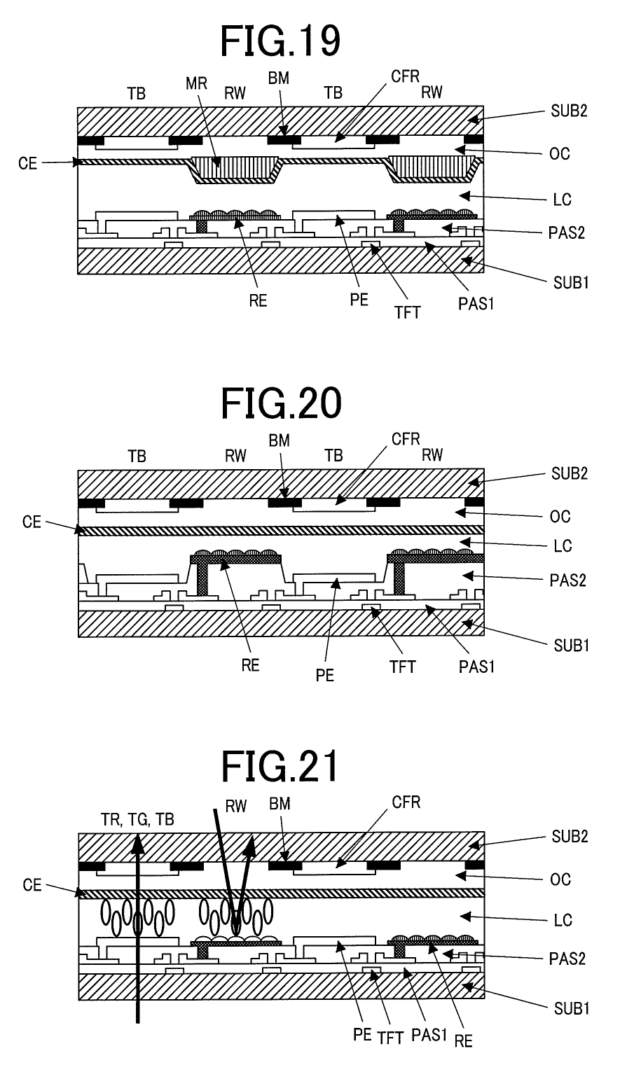

FIG. 19 and FIG. 20 show the structures in this case. In this case, it is not necessary that the ratio for the thickness of the liquid crystal layer is 2:1 between the transmission type sub-pixel (TR, TG, TB) and the reflection type sub-pixel (RW). Further, the step for providing the difference in the thickness of the liquid crystal layer may be formed to any of glass substrates, that is, the glass substrate (SUB2) as shown in FIG. 19 or glass substrate (SUB1) as shown in FIG. 20. In this case, even when a step for providing the difference for the thickness of the liquid crystal layer is formed, since the boundary for the stepped portion coincides with the boundary of the sub-pixel, there is no particular requirement for adding the light shielding film and the aperture ratio is not lowered. In FIG. 19 and FIG. 20, the alignment films (AL1, AL2), the polarization plates (POL1, POL2) and the retardation plate (RET1, RET2) are not illustrated.

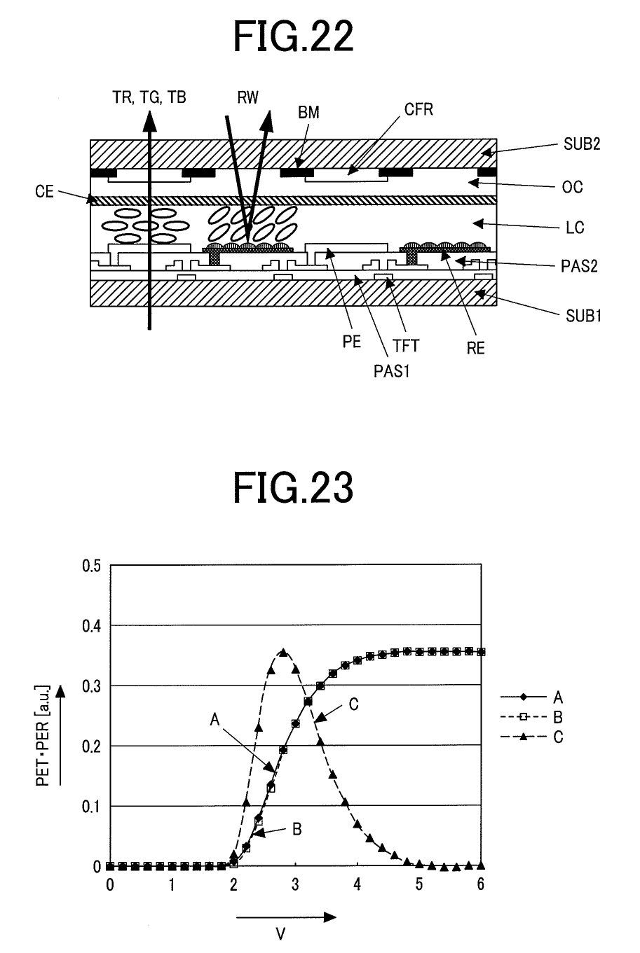

FIG. 21 and FIG. 22 are views for explaining the operation of the liquid crystal display panel of this embodiment. FIG. 21 and FIG. 22 are cross sectional views showing the schematic cross sectional structure taken along line A-A′ in FIG. 2. Further, in FIG. 21 and FIG. 22, the alignment films (AL1, AL2), the polarization plates (POL1, POL2), and the retardation plates (RET1, RET2) are not illustrated.

In a case of the VA system (vertical alignment system) liquid crystal display panel, when the driving voltage to be applied to the liquid crystal layer (LC) is lower than the threshold value voltage or extremely lower, since the optical phase difference in the liquid crystal layer (LC) is substantially 0, both the transmission type sub-pixels (TR, TG, TB) and the reflection type sub-pixel (RW) can display “black” without forming the step for providing the difference to the thickness of the liquid crystal layer to the reflection type sub-pixel (RW).

Upon displaying “white”, for obtaining an optical phase difference π (pai) necessary for white display, since the optical channel length of the reflection type sub-pixel (RW) is about twice the transmission type sub-pixel (TR, TG, TB), it is necessary to decrease the effective refractive index anisotropy of the liquid crystal layer (LC) by lowering the voltage applied to the liquid crystal layer (LC) of the reflection type sub-pixel (RW) than the voltage applied to the liquid crystal layer (LC) of the transmission type sub-pixels (TR, TG, TB) in order to align the optical phase difference π. With the constitution as described above, both the transmission type sub-pixels (TR, TG, TB) and the reflection type sub-pixel (RW) can conduct “white” display.

FIG. 23 is a graph showing a relation of the application voltage (V) to the transmittance (PET) and the reflectance (PER) in the VA system (vertical alignment system) liquid crystal display panel. “A” in FIG. 23 represents the transmittance (PET) of the transmission type sub-pixels (TR, TG, TB), “B” in FIG. 23 represents the reflectance (PER) of the reflection type sub-pixel (RW) in a case of forming a step for providing a difference to the thickness of the liquid crystal layer, and “C” in FIG. 23 represents the reflectance (PER) of the reflection type sub-pixel (RW) in a case not forming the step for providing the difference to the thickness of the liquid crystal layer.

To the application voltage (V)—transmittance (PET) characteristic for the transmission type sub-pixels (TR, TG, TB) shown by “A” in FIG. 23, the voltage obtaining the maximum reflectance in the application voltage (V)—reflectance (PER) characteristic for the reflectance type sub-pixel (RW) is substantially identical with that in the application voltage (V)—transmittance (PET) characteristic for the transmission type sub-pixels (TR, TG, TB).

On the other hand, in the application voltage (V)-reflectance (PER) characteristic shown by “C” in FIG. 23, in a case of not forming the step for providing the difference to the thickness of the liquid crystal layer, the voltage obtaining the maximum reflectance is lower than that in the application voltage (V)—transmittance (PET) characteristic for the transmission type sub-pixels (TR, TG, TB).

That is, in a case of not forming the step for providing the difference to the thickness of the liquid crystal layer, the potential difference between the minimum driving voltage and the maximum driving voltage applied to the liquid crystal layer (LC) of the reflection type sub-pixel (RW) is less than the potential difference between the minimum driving voltage and the maximum driving voltage applied to the liquid crystal layer (LC) of the transmission type sub-pixels (TR, TG, TB) upon “white” display.

In the foregoing explanation, while descriptions have been made to the embodiment of applying the invention to the VA system liquid crystal display panel, the invention is not restricted to the VA system liquid display panel but is applicable also to the TN system liquid crystal display panel, the ECB system liquid crystal display panel, or the IPS system liquid crystal display panel.

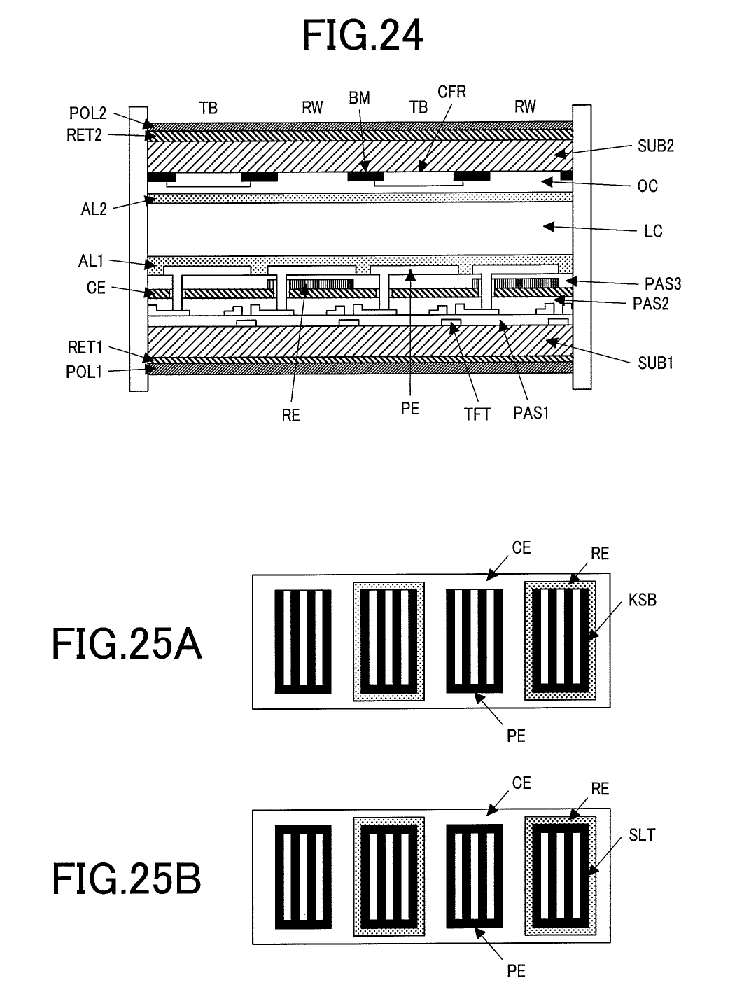

FIG. 24 is a cross sectional view showing a schematic cross sectional structure of other example of the liquid crystal display panel of this embodiment. FIG. 24 is an embodiment in which the invention is applied to the IPS system liquid crystal display panel.

Also in the liquid crystal display panel shown in FIG. 24, a pair of glass substrate (SUB1, SUB2) are disposed with the liquid crystal layer (LC) being put therebetween. In this example, the side of the main surface of the glass substrate (SUB2) is a view side.

To the glass substrate (SUB2) on the side of the liquid crystal layer, a light shielding film (BM), a color filter (CFR), a protective film (OC), and an alignment film (AL2) are formed orderly from the glass substrate (SUB2) to the liquid crystal layer (LC). A retardation plate (RET2) and a polarization plate (POL2) are disposed to the outside of the glass substrate (SUB2).

Further, to the glass substrate (SUB1) on the side of the liquid crystal layer, thin film transistors (TFT), an interlayer insulative film (PAS1), scanning lines (also referred to as gate line) (not illustrated), an interlayer dielectric film (PAS2), video lines (also referred to as source lines or drain lines) (not illustrated), a counter electrode (CE), a reflection electrode (RE), an interlayer dielectric film (PAS3), a pixel electrode (PE), and an alignment film (AL1) are formed orderly from the glass substrate (SUB1) to the liquid crystal layer (LC). To the outside of the glass substrate (SUB1), a retardation plate (RET1) and a polarization plate (POL1) are disposed.

FIGS. 25A and 25B are views for explaining an electrode shape in the liquid crystal display panel shown in FIG. 24.

In the example shown in FIG. 25A, a counter electrode (CE) is formed in a planar shape, and a pixel electrode (PE) has a plurality of comb electrodes (KSB). Further, in an example shown in FIG. 25B, a counter electrode (CE) is formed in a planar shape and a pixel electrode (PE) has a plurality of slits (SLT) closed at both ends. Further, the pixel electrode (PE) and the counter electrode (CE) are superimposed by way of the interlayer insulative film (PAS3), to constitute a holding capacitance.

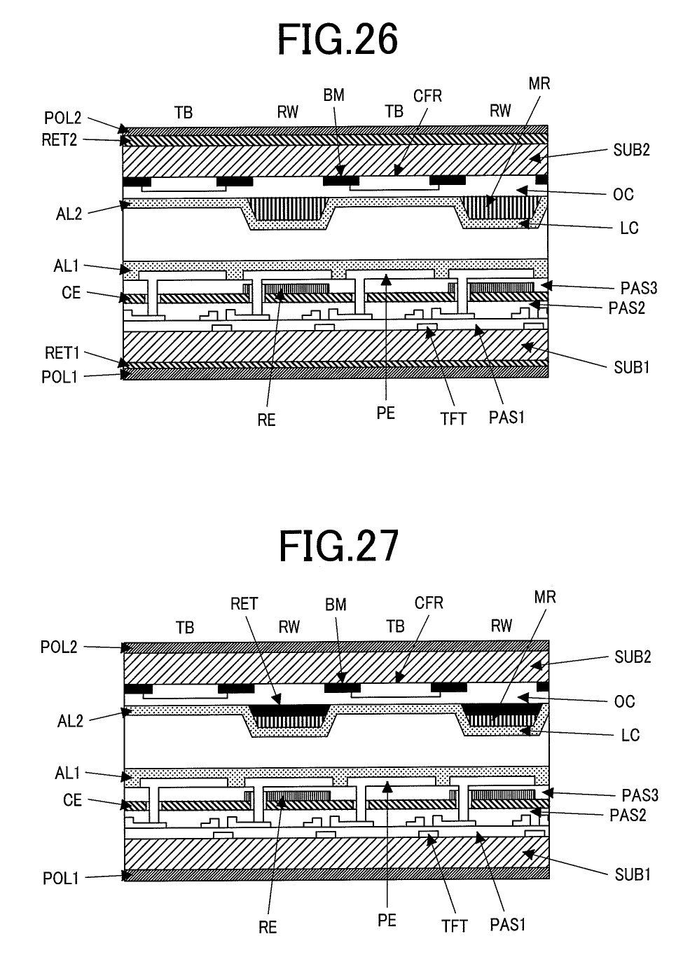

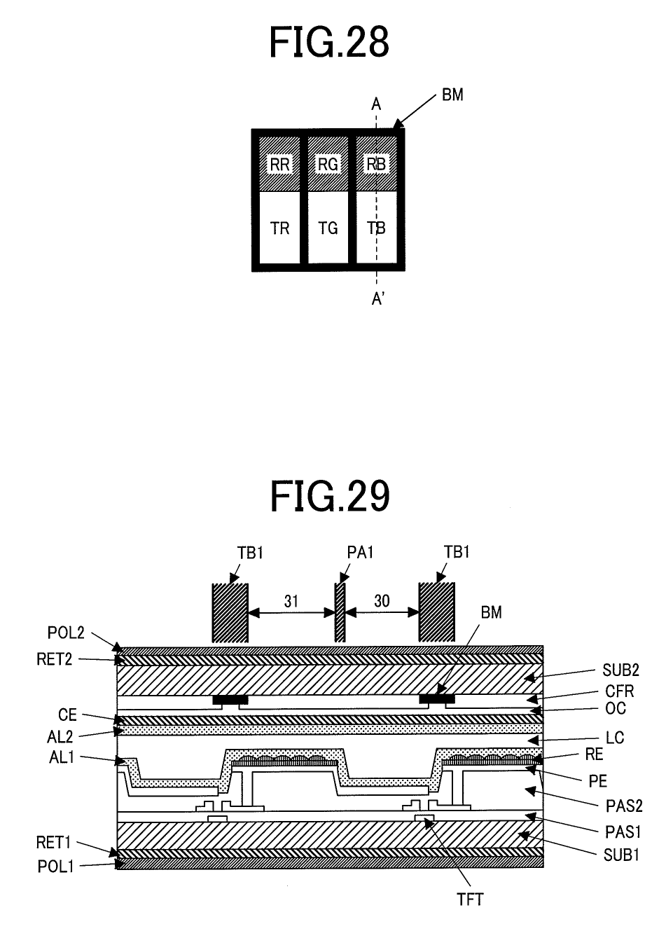

In the liquid crystal display panel shown in FIG. 24, a step forming layer (MR) for providing a difference to the thickness of the liquid crystal layer may be formed to the glass substrate (SUB2) on the side of the liquid crystal layer of the reflection type sub-pixel (RW) as shown in FIG. 26.

Further, in the liquid crystal display panel shown in FIG. 24, a retardation plate (½ wavelength plate) (RET) may be formed to the reflection type sub-pixel (RW) and the retardation plates (RET1, RET2) may be saved as shown in FIG. 27. The constitution of FIG. 27 is not restricted to the IPS system liquid crystal display panel but is applicable also to the TN system liquid crystal display panel, the ECB system liquid crystal display panel or the VA system liquid crystal display panel.

While the invention made by the present inventor has been described specifically with reference to the preferred embodiments, but the invention is not restricted to the embodiments but may be modified variously within a range not departing the gist thereof.

What is claimed is:

1. A liquid crystal display device comprising:
a first substrate;
a second substrate; and
a liquid crystal display panel having liquid crystals put between the first substrate and the second substrate,
wherein: the liquid crystal display panel has a plurality of sub-pixels;
the plurality of sub-pixels have, as one basic unit, first to third at least three transmission type sub-pixels and a reflection type sub-pixel;
the first to third transmission type sub-pixels and the reflection type sub-pixel are independently driven under control;
the first transmission type sub-pixels displays a first color;
the second transmission type sub-pixels displays a second color;
the third transmission type sub-pixels displays a third color; and
the reflection type sub-pixel displays a white color.

2. A liquid crystal display device according to claim 1,
wherein a luminance of the white color displayed by the reflection type sub-pixel is determined based on a luminance for the first color displayed by the first transmission type sub-pixel, a luminance for the second color displayed by the second transmission type sub-pixel, and a luminance for the third color displayed by the third transmission type sub-pixel.

3. A liquid crystal display device according to claim 2,
wherein the luminance of the white color displayed by the reflection type sub-pixel is the sum of the luminance for the first color displayed by the first transmission type sub-pixel, the luminance for the second color displayed by the second transmission type sub-pixel, and the luminance for the third color displayed by the third transmission type sub-pixel.

4. A liquid crystal display device according to claim 1,
wherein a thickness of a liquid crystal layer at the first to the third transmission type sub-pixels is equal with a thickness of a liquid crystal layer at the reflection sub-pixel.

5. A liquid crystal display device according to claim 4,
wherein a potential difference between a minimum driving voltage and a maximum driving voltage applied to the liquid crystal layer at the reflection type sub-pixel is less than a potential difference between a minimum driving voltage and a maximum driving voltage applied to a liquid crystal layer at the first to third transmission type sub-pixels.

6. A liquid crystal display device according to claim 1,
wherein a thickness of a liquid crystal layer of the reflection type sub-pixel is less than a thickness of a liquid crystal layer at the first to third transmission type sub-pixels.

7. A liquid crystal display device according to claim 6,
wherein the reflection type sub-pixel has a step forming layer for adjusting the thickness of liquid crystal layer at the reflection type sub-pixel in the first substrate or the second substrate.

8. A liquid crystal display device comprising:
a first substrate;
a second substrate; and
a liquid crystal display panel having liquid crystals put between the first substrate and the second substrate,
wherein: the liquid crystal display panel has a plurality of pixels;
the plurality of pixels have first to third at least three transmission type sub-pixels and a reflection type sub-pixel;
the first to third transmission type sub-pixels and the reflection type sub-pixels are independently driven respectively under control;
a basic unit is formed of the four pixels which are disposed periodically;
the basic unit has four first to fourth reflection type sub-pixels which are formed in the four pixels respectively, and has first to fourth reflection type sub-pixels which are formed in the four pixels respectively;
the four first transmission type sub-pixels and the first reflection type sub-pixel display a first color;
the four second transmission type sub-pixels and the second reflection type sub-pixel display a second color;
the four third transmission type sub-pixels and the third reflection type sub-pixel display a third color; and
the fourth reflection type sub-pixels displays a white color.

9. A liquid crystal display device according to claim 8,
wherein: a luminance for the first color displayed by the first reflection type sub-pixel is determined based on a luminance for the first color displayed at the four first transmission type sub-pixels in the basic unit;
a luminance for the second color displayed by the second reflection type sub-pixel is determined based on a luminance for the second color displayed at the four second transmission type sub-pixels in the basic unit;
a luminance for the third color displayed by the third reflection type sub-pixel is determined based on a luminance for the third color displayed at the four third transmission type sub-pixels in the basic unit; and
a luminance for the white color displayed by the fourth reflection type sub-pixel is determined based on the luminance for the first color displayed at the four first transmission type sub-pixels, the luminance for the second color displayed at the four second transmission type sub-pixels, and the luminance for the third color displayed at the four third transmission type sub-pixel.

10. A liquid crystal display device according to claim 9,
wherein: the luminance for the first color displayed by the first reflection type sub-pixel is an average value of the luminance for the first color displayed at the four first transmission type sub-pixels;
the luminance for the second color displayed by the second reflection type sub-pixel is an average value for the luminance for the second color displayed at the four second transmission type sub-pixels;
the luminance for the third color displayed by the third reflection type sub-pixel is an average value of the luminance for the third color displayed at the four third transmission type sub-pixels; and
the luminance for the white color displayed by the fourth reflection type sub-pixel is a sum of the average value of the luminance for the first color displayed at the four first transmission type sub-pixels, the average value of the luminance for the second color displayed at the four second transmission type sub-pixels, and an average value of the luminance for the third color displayed at the four third transmission type sub-pixels.

11. A liquid crystal display device according to claim 8,
wherein a thickness of a liquid crystal layer at the first to third transmission type sub-pixels is equal with a thickness of a liquid crystal layer a the reflection type sub-pixel.

12. A liquid crystal display device according to claim 11,
wherein a potential difference between a minimum driving voltage and a maximum driving voltage applied to the liquid crystal layer at the reflection type sub-pixel is less than a potential difference between a minimum driving voltage and a maximum driving voltage applied to the liquid crystal layer at the first to third transmission type sub-pixels.

13. A liquid crystal display device according to claim 8,
wherein a thickness for a liquid crystal layer at the reflection type sub-pixel is less than a thickness of a liquid crystals at the first to third transmission type sub-pixels.

14. A liquid crystal display device according to claim 13,
wherein the reflection type sub-pixel has a step forming layer for adjusting the thickness of the liquid crystal layer at the reflection type sub-pixel on the first substrate or the second substrate.

15. A liquid crystal display device comprising:
a first substrate;
a second substrate; and
a liquid crystal display panel having liquid crystals put between the first substrate and the second substrate,
wherein: the liquid crystal display panel has a plurality of sub-pixels;
each of the plurality of sub-pixels has a pixel electrode formed on the first substrate and a counter electrode formed on the second substrate, and an electric field is generated by the pixel electrode and the counter electrode to drive the liquid crystals;
the plurality of sub-pixels have, as one base unit, first to third at least three transmission type sub-pixels and a reflection type sub-pixel;
the first to third transmission type sub-pixels and the reflection type sub-pixel are independently driven under control respectively;
the first transmission type sub-pixel displays a first color;
the second transmission type sub-pixel displays a second color;
the third transmission type sub-pixel displays a third color; and
the reflection type sub-pixel displays a white color.

16. A liquid crystal display device according to claim 15,
wherein the reflection type sub-pixel has a reflection electrode formed above the pixel electrode or below the pixel electrode.

17. A liquid crystal display device comprising;
a first substrate;
a second substrate; and
a liquid crystal display panel having liquid crystals put between the first substrate and the second substrate,
wherein: the liquid crystal display panel has a plurality of sub-pixels;
each of the plurality of sub-pixels has a pixel electrode and a counter electrode formed on the first substrate, an electric field is generated by the pixel electrode and the counter electrode to drive the liquid crystals;
the plurality of the sub-pixels have, as one basic unit, at least three first to third transmission type sub-pixels and a reflection type sub-pixel;
the first to third transmission type sub-pixels and the reflection type sub-pixel are independently driven respectively under control;
the first transmission type sub-pixel displays a first color;
the second transmission type sub-pixel displays a second color;
the third transmission type sub-pixel displays a third color; and
the reflection type sub-pixel displays a white color.

18. A liquid crystal display device according to claim 17,
wherein the reflection type sub-pixel has a reflection electrode formed above the counter electrode or below the counter electrode.

19. A liquid crystal display device according to claim 17,
wherein: the counter electrode is a planar electrode;
an interlayer dielectric film formed on the planar counter electrode is provided; and
the pixel electrode is formed on the interlayer dielectric film.

20. A liquid crystal display device according to claim 17,
wherein the reflection type sub-pixel has a retardation plate in the second substrate.
